(19) United States
(12) Patent Application Publication
(10) Pub. No.: US 2003/0184586 A1
(43) Pub. Date: Oct. 2, 2003

(54) Illustration creating program

(75) Inventors: Shunji Haraguchi, Nakahara-ku (JP); Ryotaro Suzaki, Chiyoda-ku (JP)

Correspondence Address: STEINBERG & RASKIN, P.C., 1140 AVENUE OF THE AMERICAS, 15th FLOOR, NEW YORK, NY, 10036-5803, US

(73) Assignees: S.E. INC.; SYSTEM PRODUCTS CORPORATION

(21) Appl. No.: 10/262,394

(22) Filed: Oct. 1, 2002

(30) Foreign Application Priority Data
Mar. 29, 2002 (JP) 2002-94353

(51) Int. Cl. G09G 5/00

(52) U.S. Cl. 345/764

(57) ABSTRACT

Provided is an illustration creating program which can be easily used even by a first-time user. When the program is started, a menu bar, a toolbox, a preview window and setting windows are displayed on a display. When a submenu item “New” is selected from a main menu item “File” of the menu bar, a drawing window is displayed on the screen. Thus, the toolbox, the preview window, a paintbrush information setting window capable of setting a tool, a color setting window, a color palette setting window, a control setting window, a layer setting window capable of setting the drawing window, and a selected-range setting window are displayed on the screen.

### BACKGROUND OF THE INVENTION

1. Field of the Invention

The present invention relates to an illustration creating program for drawing or painting a picture on a personal computer.

2. Description of the Related Art

Heretofore, there has been an illustration creating program capable of drawing a picture or painting the drawn picture on a screen of a personal computer.

In the case of the conventional illustration creating program, a toolbox is displayed on the screen. The toolbox includes a drawing tool for drawing a line or a figure, a character tool for writing a character, and a painting tool for painting a portion surrounded by the lines.

A user selects an appropriate tool from the above-mentioned toolbox so as to draw a line or paint a picture.

To draw a line, the thickness, type, color or the like of the line can be set. Setting of the thickness, type, color or the like of the line is performed in the following manner. That is, a line setting file is selected from a menu bar displayed on the screen of the personal computer independently of the toolbox, and the line setting file is opened. Then, the thickness, type, color or the like of the line is set by using the setting file. In the menu bar, a menu of each setting file is indicated by a file name, a keyword, or the like.

To write a character by using the character tool, a character setting file is selected from the menu bar and is opened, as in the case of the setting of the line. Then, the font, size or the like of the character is set by using the character setting file. For painting, a painting file is selected from the menu bar and is opened in the same manner, and then the color or type of painting is set by using the painting file.

The conventional illustration creating program has various functions which are not displayed in the above-mentioned toolbox. For example, the functions include the function of setting a layer, the function of setting a drawing window for drawing an image, and so forth.

The use of the above-mentioned various functions makes it possible to draw an illustration or the like.

The above-described conventional illustration creating program has a problem. More specifically, after the selection of a desired tool from the toolbox displayed on the screen, a setting screen must be selected from the menu bar and be displayed at every time of setting of the tool. Thus, at every time of setting, a setting screen is selected from a menu screen and is displayed so as to set a tool. This is very troublesome.

The conventional illustration creating program has another problem. More specifically, the above-mentioned menu bar includes the name of each setting file or the keyword thereof which is represented as characters, but the sight of only the file name or the keyword may not allow a user to know what type of function the setting file has, namely, the contents of the setting file. When the display of only the menu bar does not allow a user to know the contents of the setting file as described above, the file must be opened to see the contents of the file.

The conventional illustration creating program has still another problem. More specifically, the illustration creating program has functions which are not displayed in the toolbox, and thus, a user may not know even what types of functions the program has unless the user is fairly expert in the use of the program. Therefore, even if the program has various functions for user's sake, a user cannot make full use of the program when the user does not know the existence of the functions.

Moreover, a user cannot find a function which is not displayed in the toolbox, when the user wants to use the function.

### SUMMARY OF THE INVENTION

It is an object of the invention to provide an illustration creating program which can be easily used even by a first-time user.

According to a first aspect of the invention, there is provided an illustration creating program which comprises the steps of: displaying on a display screen a drawing window which displays a drawn illustration or the like, a toolbox which displays tools to draw an illustration or the like, setting windows which set the tools and the drawing window and display setting statuses, and a preview window which previews the drawing window; displaying illustrations indicative of features of the tools in the toolbox; and displaying tables or illustrations indicative of the setting statuses in the setting windows.

According to a second aspect of the invention, there is provided an illustration creating program which further comprises the steps of: storing a procedure for creating an illustration or the like and the setting statuses of the setting windows; and reproducing the stored creating procedure and the stored setting statuses.

### BRIEF DESCRIPTION OF THE SEVERAL VIEWS OF THE DRAWINGS

FIG. 1 is a schematic view of a display screen according to an embodiment of the invention; and

FIG. 2 is a conceptual diagram of a general configuration according to the embodiment of the invention.

### DETAILED DESCRIPTION OF THE INVENTION

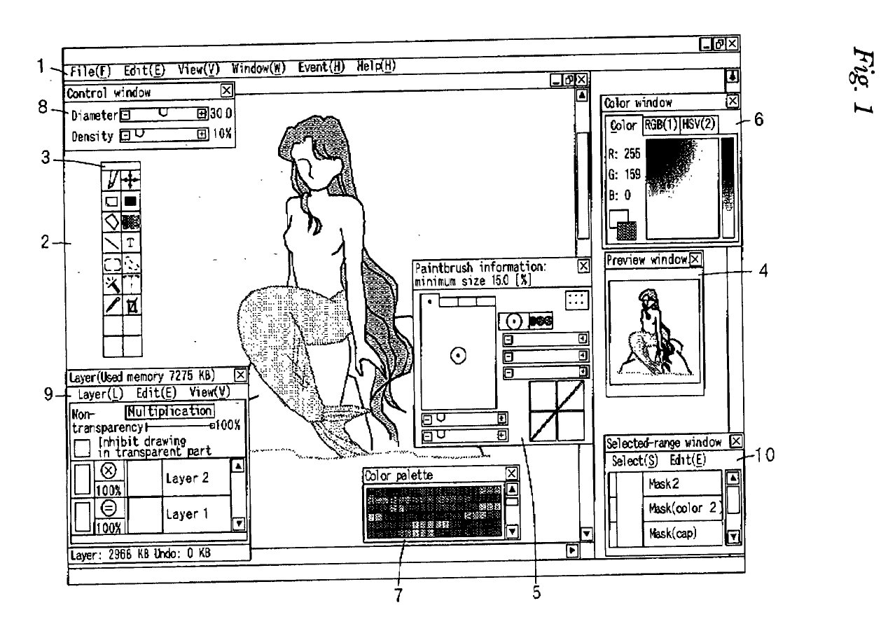

FIG. 1 shows an embodiment of the invention, and shows a screen of a personal computer on which a program of the invention is run.

On the screen, displayed are a menu bar 1, a drawing window 2 for drawing an image, a toolbox 3, a preview window 4, and a plurality of setting windows 5 to 10.

In the menu bar 1, main menu items such as “File”, “Edit”, “Select”, “Filter”, “Event”, “View”, “Window” and “Help” are displayed, and submenu items (not shown) appear through the selection of one of the main menu items. Furthermore, lower-level submenu items can be selected by selecting one of the submenu items.

However, some menus may have only the submenu items without having the lower-level submenu items.

The selection of one of the above-mentioned menu items makes it possible to select one of all functions that are handled by the program.

Incidentally, the menu items of the menu bar 1 are represented as characters, as has been conventional.

In the drawing window 2, displayed is an illustration or the like drawn by a user using various tools.

In the toolbox 3, illustrations are displayed to indicate the respective features of various tools. For example, a paintbrush drawing tool is shown by an illustration of a paintbrush, and a painting tool is shown by an illustration of a bucket.

The toolbox 3 displayed as described above includes a layer shifting tool, a figure drawing tool, a range selecting tool, a gradation tool, a character writing tool, a character selecting tool, a trimming tool, an image rotating tool, an image shifting tool, a zoom-in tool, a zoom-out tool, and so on, in addition to the above-mentioned tools. Illustrations are displayed to indicate the respective features of the tools.

In the preview window 4, an illustration drawn in the drawing window 2 is previewed. Therefore, the whole illustration can be seen even during operation with the drawing window partly zoomed.

The setting windows 5 to 10 include a paintbrush information setting window 5 capable of setting a tool, a color setting window 6, a color palette setting window 7, a control setting window 8, a layer setting window 9 capable of setting the drawing window 2, and a selected-range setting window 10.

The paintbrush information setting window 5 allows setting the type of paintbrush, the thickness of a line, the strength of tool force, or the like. The types of paintbrushes include a pencil, watercolors, gradation, an airbrush, an eraser, and so on. The thickness of the paintbrush, the tool force or the like can be set for each of these types of paintbrushes. Therefore, various paintbrushes can be used according to the type of a line to be drawn.

The control setting window 8 displays the thickness and density of a line in accordance with the paintbrush information setting window 5.

The color setting window 6 permits selecting a color to be used on the drawing window 2 from among gradations of color tones. The color palette setting window 7 allows selecting a color to be used on the drawing window 2 from among a plurality of types of predetermined colors.

A user can select from among colors on the color palette setting window 7 when the user needs only existing colors set by the color palette setting window 7, or the user can select from among colors on the color setting window 6 when the user wants to use colors other than the existing colors.

The layer setting window 9 allows selecting a layer on the drawing window 2 using a layer function and also allows setting the layer. A general layer function is used as the layer function.

The selected-range setting window 10 permits selecting parts of an illustration drawn on the drawing window 2, and permits displaying each of the selected parts if the selected parts are stored.

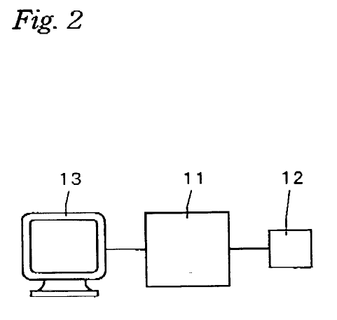

In the embodiment, as shown in FIG. 2, a tablet 12 is connected to a PC main unit 11, and a display 13 is also connected to the PC main unit 11. The tablet 12 comprises a pen-type tool and a board-shaped input device, wherein an illustration is drawn on the input device by using the pen-type tool, whereby the illustration is drawn on the drawing window 2 on the display.

The use of the tablet 12 makes it possible to display an illustration on the display 13 as if the illustration were drawn on the display 13.

Next, an example of use of the program of the invention will be described.

A user starts the program by operating the PC main unit 11. When the program is started, the windows other than the drawing window 2, and the like are displayed on the display 13. More specifically, the menu bar 1, the toolbox 3, the preview window 4 and the setting windows 5 to 10 are displayed.

After starting the program, the user selects the submenu item “New” from the main menu item “File” of the menu bar 1. When “New” is selected, the drawing window 2 is displayed on the screen, and the screen shown in FIG. 1 appears.

Then, the user selects the paintbrush drawing tool from the toolbox 3 in order to draw a rough sketch for an illustration. Furthermore, the user sets the type and thickness of paintbrush or the like by using the paintbrush information setting window 5. After setting the paintbrush, the user sets the color of the paintbrush. Setting of the color may be performed by using the color palette setting window 7 or the color setting window 6.

After selecting the paintbrush and the color of the paintbrush, the user draws the rough sketch for the illustration on the drawing window 2 by using the tablet 12. When the tablet 12 is not used, a mouse may be used for drawing.

Moreover, a first-level layer is displayed on the displayed drawing window 2. Thus, drawing an illustration directly on the displayed drawing window 2 corresponds to drawing the illustration on the first-level layer. In this case, an icon representative of the first-level layer appears on the layer setting window 9. Furthermore, the illustration drawn on the layer is previewed on the icon indicative of the layer.

Therefore, the user can easily see which layer is in current use, and moreover, the user can know at a glance on which layer and what the user has drawn.

Furthermore, when the rough sketch is drawn on the drawing window 2, the rough sketch is previewed on the preview window 4. Thus, even when the drawing window 2 is zoomed, the whole sketch drawn on the drawing window 2 can be seen on the preview window 4, and therefore, the user can continue drawing while always seeing the relative positions of parts of the sketch.

After completing the rough sketch in the above-described manner, the user selects the item “New” from the item “Layer” of the layer setting window 9. When “New” is selected, a second-level layer is displayed on the drawing window 2. In this case, the second-level layer is superimposed on the first-level layer. In this case, the first-level layer may be set by using the layer setting window 9 so that the whole rough sketch on the first-level layer is displayed in lighter color.

The rough sketch on the first-level layer is displayed in lighter color as mentioned above, and this facilitates distinguishing between the rough sketch and a final illustration to be drawn on the second-level layer.

Then, the user draws the final illustration on the superimposed second-level layer. The rough sketch on the first-level layer is under the second-level layer, and therefore, the user can draw the final illustration on the second-level layer only by tracing the rough sketch on the first-level layer.

After completing the final illustration on the second-level layer in the above-described manner, the user deletes the first-level layer by using the layer setting window 9, because the rough sketch on the first-level layer is not necessary.

Subsequently, the user paints the drawn illustration. For instance, the user increases the thickness of the paintbrush by using the paintbrush information setting window 5 and further selects a color by using the color setting window 6. Then, the user can paint the illustration by using this paintbrush.

The illustration may be painted in the following manner: the painting tool of the toolbox 3 is clicked, then a color is selected by using the color setting window 6, and a portion of the illustration to be painted is clicked.

The use of the paintbrush tool for painting makes it possible to paint a small area, and the use of the painting tool makes it possible to paint a wide area at a time. Accordingly, various tools can be used according to the area to be painted or the way of painting.

The illustration can be drawn on the drawing window 2 in the above-described manner.

When the illustration is drawn as described above, all of the tools and setting windows required to draw the illustration are displayed on the screen. Therefore, the user can use various functions without confusion.

Moreover, the settings of the functions are displayed on the screen, and thus, it is not necessary to open other menus or files in order to display the settings. Therefore, the functions can be set with great ease.

Furthermore, the illustrations or tables are displayed to indicate the features of the tools of the toolbox 3 and the setting windows 5 to 10 so that what type of function each tool or window has is clear at a glance. This makes it easier to know what type of function each tool or window has, and therefore, even a beginner who is not familiar with the program can easily use the program.

Moreover, the program of the embodiment has an event reproducing function. The event reproducing function refers to the function of storing the drawing sequence of a drawn illustration by the program and reproducing the stored sequence.

The description is given with regard to details of the event reproducing function.

After drawing an illustration through the above-described procedure, the user selects the main menu item “Event” of the menu bar 1 and further selects the submenu item “Save event file”. The selection of “Save event file” allows the program to store the procedure through which the user has drawn the illustration.

In this case, the setting statuses of the setting windows 5 to 10, as well as the illustration drawn on the drawing window 2, are stored.

The event file once stored in the above-mentioned manner can be reproduced many times by selecting “Reproduce event” from “Event” of the menu bar 1. During reproduction, the whole screen shown in FIG. 1 appears. In other words, not only the drawing window 2 but also the setting windows 5 to 10 appear.

Therefore, the screen permits seeing not only the drawing sequence of the drawn illustration but also the setting statuses of the setting windows 5 to 10.

Furthermore, when corrections are made on the illustration saved as the event file, the procedure of correction can be added to the end of the event file. Therefore, all operations performed by a single drawing window 2 can be stored as a series of flows, which can be reproduced.

The work flow is reproduced by means of the event file as described above, and thus, the user can review his or her operation. Moreover, the user can see the procedures of others' operations. The user sees the event files of other persons, and thus, the user can learn how they set the setting windows 5 to 10 or how they use the tools set by the setting windows 5 to 10.

Furthermore, illustrations created by the program of the embodiment can be transmitted or received between users via a communication network such as the Internet. Moreover, a leased site may be provided on the Internet so that illustrations can be posted to the leased site.

The use of the Internet or the like makes it possible to view illustrations of a larger number of persons and also makes it possible to view the event files of the illustrations. Therefore, the user can learn techniques which various types of persons use to draw illustrations, and the drawing sequences of the illustrations.

As described above, in the embodiment, almost all the tools in use and the setting windows for the tools are displayed on the screen, and thus, the tools can be selected and set with great ease. Therefore, even a beginner can easily draw an illustration.

Furthermore, the use of the even function enables the user to learn others' techniques for drawing illustrations, and therefore, the technique for drawing illustrations can be dramatically improved.

According to the first aspect of the invention, there is provided an illustration creating program which comprises the step of: displaying on a display screen a drawing window which displays a drawn illustration or the like, a toolbox which displays tools to draw an illustration or the like, setting windows which set the tools and the drawing window and display setting statuses, and a preview window which previews the drawing window. Therefore, the user can recognize the types of the tools only by seeing the display screen.

Moreover, the tools, the drawing window or the like can be set on the display screen. Therefore, even a first-time user can easily use the program of the invention. Moreover, the drawing window is previewed by the preview window, and therefore, the user can continue drawing while seeing the overall illustration.

Moreover, the toolbox displays illustrations indicative of features of the tools, and the setting windows display tables or illustrations indicative of the setting statuses. Therefore, the user can know what types of functions the tools have or how the tools are set, only by taking a glance at the toolbox or the setting windows.

According to the second aspect of the invention, there is provided an illustration creating program which further comprises the steps of: storing a procedure for creating an illustration or the like and the setting statuses of the setting windows; and reproducing the stored creating procedure and the stored setting statuses. Therefore, the user can see the creating procedure by displaying on the screen a file storing the reproduced contents.

Moreover, the user can learn others' techniques for drawing illustrations by reproducing the creating procedures or the setting statuses of other persons.

What is claimed is:

1. An illustration creating program comprising the steps of:
displaying on a display screen a drawing window which displays a drawn illustration or the like, a toolbox which displays tools to draw an illustration or the like, setting windows which set said tools and said drawing window and display setting statuses, and a preview window which previews said drawing window;
displaying illustrations indicative of features of said tools in said toolbox; and
displaying tables or illustrations indicative of the setting statuses in said setting windows.

2. The illustration creating program according to claim 1, further comprising the steps of:
storing a procedure for creating an illustration or the like and the setting statuses of said setting windows; and
reproducing the stored creating procedure and the stored setting statuses.
